(19) United States
(12) Patent Application Publication
(10) Pub. No.: US 2004/0189191 A1
(43) Pub. Date: Sep. 30, 2004

(54) Organic EL display panel and method of manufacturing the same

(75) Inventors: Isamu Ohshita, Yamagata-ken (JP); Kenichi Okuyama, Yamagata-ken (JP); Takemi Naito, Yamagata-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Tohoku Pioneer Corporation

(21) Appl. No.: 10/809,859

(22) Filed: Mar. 26, 2004

(30) Foreign Application Priority Data
Mar. 27, 2003 (JP) 2003-086794
Apr. 22, 2003 (JP) 2003-116507

(51) Int. Cl. H01J 1/62

(52) U.S. Cl. 313/504

(57) ABSTRACT

It is an object of the invention to improve an outer appearance and the contrast of an organic EL display panel. An organic EL display panel includes a cover which has a transparency and is provided for enclosing organic EL device(s) formed on a substrate having a transparency. The display panel has transmission vision preventing means formed by providing at least colored portions in the cover. By virtue of non-luminescent areas located on the outside of the luminescent area, it is possible to prevent a poor outer appearance caused by the interior of the display panel visible from the outside of the panel.

### BACKGROUND OF THE INVENTION

The present invention relates to an organic EL (Electroluminescent) display panel formed by including a cover having a transparency.

The present application claims priority from Japanese Applications Nos. 2003-86749 and 2003-116507, the disclosures of which are incorporated herein by reference.

An organic EL display panel comprises a substrate, one or more organic EL devices each including a pair of electrodes and an organic layer (containing a luminescent layer) interposed between the electrode pair. The one or more organic EL devices are used as surface luminescent elements and arranged on the substrate, thereby forming a display area for the organic EL display panel. However, since there are many deterioration factors such as moisture and oxygen gas which cause dark spots or the like, it is necessary to provide a cover to cover the organic EL device(s) so as to protect them from these deterioration factors.

A cover for covering the organic EL device(s) is usually made of metal or glass, but recently it has been made of glass rather than metal. This is because: i) a cover made of glass has a higher smoothness than a cover made of metal, and it is possible to inhibit an occurrence of gap on an interface between the cover and an adhesive agent bonding together the substrate and the cover, ii) since a cover made of glass has an adhesion strength higher than that of metal cover, it is possible to prohibit an invasion of external deterioration factors (moisture, oxygen gas, etc.) into the organic EL device(s), iii) since the thickness of a glass cover is usually 0.7-1.1 mm and the thickness of a metal cover is usually 1.3-1.4 mm, it is allowed to produce an organic EL display panel with a thin thickness.

FIG. 1 is an explanatory view schematically showing a conventional organic EL display panel 1 formed by including a cover having a transparency. As shown, organic EL devices 3 are formed by laminating, in the following order on a glass substrate 2, lower electrodes 3a formed by a transparent material such as ITO and IZO and serving as anodes, an organic luminescent layer 3b, and upper electrodes 3c formed of a metal having a small work function and serving as cathodes. Spaced from the organic EL devices 3, a glass cover 4 is air-tightly bonded to the glass substrate 2 by virtue of an adhesive agent 6. Then, desiccating means 7 capable of chemically absorbing moisture is attached to the inner side of the glass cover 4 (Japanese Unexamined Patent Application Publication No. 9-148066).

According to the above-mentioned prior art, there are formed a luminescent area A located between two ends D of the area of the upper electrodes 3c which partially forms the organic EL devices 3, and non-luminescent areas B interposed between the ends D of the area of the upper electrodes 3 and ends C of the cover 4. The inner side of the luminescent area A is not visible from the outside of the organic EL display panel 1 due to the presence of the upper electrodes 3c. On the other hand, since the cover 4 has a certain transparency, the inner side of the non-luminescent areas B are visible from the outside of the organic EL display panel 1, hence undesirably causing a transmission vision.

If the cover 4 is formed by a transparent material such as glass, the backside of the organic EL display panel is undesirably visible from the front side thereof. As a result, since driving circuit, printed circuit board and electronic parts are mounted on the backside of the organic EL display panel, there is a problem that the outer appearance of the display panel is poor. Besides, if the upper electrodes 3c are formed by a material having a certain transparency, the entire area on the backside of the organic EL display panel 1 becomes undesirably visible.

### SUMMARY OF THE INVENTION

The present invention has been accomplished in order to solve the above problem, and it is an object of the invention to prevent an undesired transmission vision from the front side of an organic EL display panel, thereby improving the contrast of the display panel.

According to one aspect of the invention, there is provided an organic EL display panel including a cover which has a transparency and is provided for enclosing organic EL device(s) formed on a substrate having a transparency, characterized in that at least non-luminescent areas of the organic EL display panel are provided with transmission vision preventing means.

According to another aspect of the invention, there is provided a method of manufacturing an organic EL display panel including a cover which has a transparency and is provided for enclosing organic EL device(s) formed on a substrate having a transparency, characterized in that the method involves an step of forming transmission vision preventing means in at least non-luminescent areas of the organic EL display panel.

### BRIEF DESCRIPTION OF THE DRAWINGS

These and other objects and advantages of the present invention will become clear from the following description with reference to the accompanying drawings, wherein:

FIG. 1 is an explanatory view showing a prior art;

FIG. 2 is an explanatory view showing a first embodiment of the present invention;

FIG. 3 is an explanatory view showing a second embodiment of the present invention;

FIG. 4 is an explanatory view showing a third embodiment of the present invention; and

FIG. 5 is an explanatory view showing a fourth embodiment of the present invention.

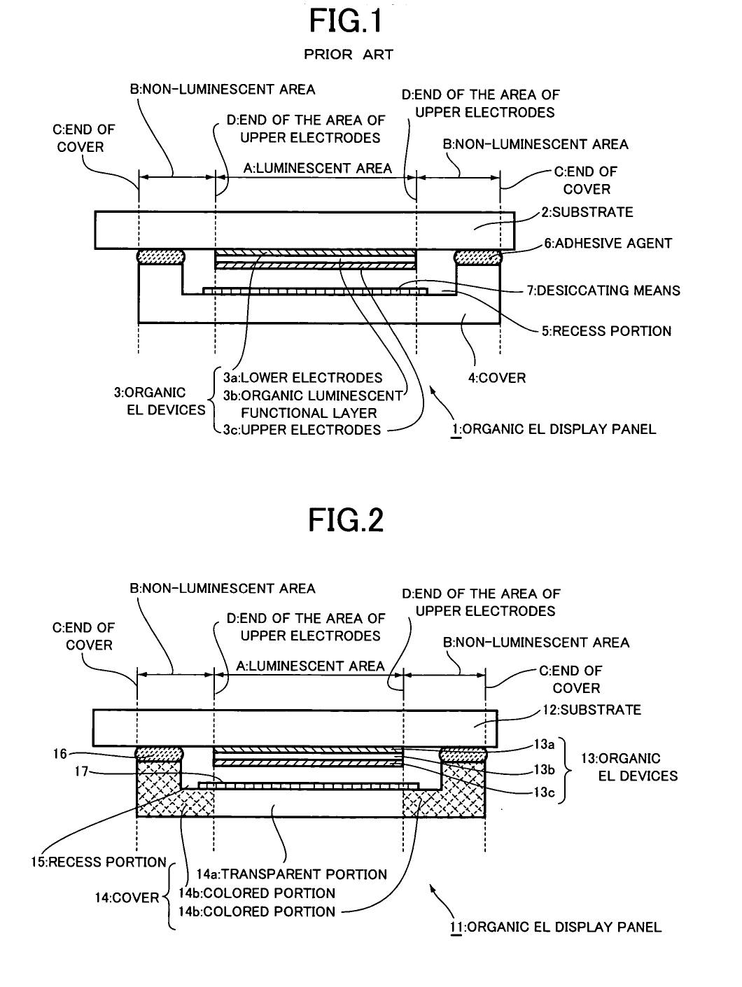

### DETAILED DESCRIPTION OF THE PREFERRED EMBODIMENTS

Several preferred embodiments of the present invention will be described below with reference to the accompanying drawings.

FIG. 2 is an explanatory view schematically showing an organic EL display panel 11 formed according to a first embodiment of the present invention. Practically, the organic EL display panel 11 can have any shape such as flat plate, film-like shape, and spherical shape, etc., and can be produced in the following manner. Namely, at first, lower electrodes 13a having a certain transparency are formed as thin film on a substrate 12 made of a transparent glass or a transparent plastic material. Then, an organic luminescent functional layer 13b and upper electrodes 13c are laminated on the lower electrodes 13, thereby forming organic EL devices 13. Subsequently, in order to protect the organic EL devices 13 (formed on the substrate 12) from the outside air, a cover 14 is bonded to the substrate 12 by means of an adhesive agent 16, followed by introducing desiccating means 17 into a recess portion 15 (facing the organic EL devices 13) of the cover 14.

Here, the lower electrodes 13a are used as anodes and the upper electrodes 13c are used as cathodes. Alternatively, the lower electrode 13a are used as cathodes and the upper electrodes 13c are used as anodes. However, at least the lower electrodes 13a should be made of a light transmissible material. Further, the anodes are made of a material having a higher work function than that of a material forming the cathodes, and are formed by a metal film such as chromium (Cr), molybdenum (Mo), nickel (Ni), and platinum (Pt), or a metal oxide film such as ITO and IZO. In contrast, the cathodes are made of a material having a lower work function than that of a material forming the anodes, and are formed by a metal film such as aluminum (Al) and magnesium (Mg), or an amorphous semiconductor such as a doped polyaniline and a doped polyphenylene vinylene, or a metal oxide such as Cr₂O₃, NiO, and Mn₂O₅. Further, it is also possible that both the lower electrodes 13a and the upper electrodes 13c can be formed by a transparent material and that a reflection film is provided on the electrode side opposite to the luminescent side.

Although an organic luminescent functional layer 13b usually comprises a hole transporting layer, a luminescent layer, and an electron transporting layer, it is also possible for an organic luminescent functional layer 13b to include a plurality of hole transporting layers, a plurality of luminescent layers, and a plurality of electron transporting layers. Further, it is possible to omit any one (or both) of the hole transporting layer and the electron transporting layer. Moreover, an organic layer such as a hole injection layer and an electron injection layer can be introduced in accordance with an actual necessity. Besides, the hole transporting layer, the luminescent layer, and the electron transporting layer should not be limited to the above-described constitution, but can be selected properly in view of an actual purpose.

The hole transporting layer can be formed by any one of various known compounds, provided that a selected compound has a high hole-mobility. In detail, the various known compounds are all organic materials including a porphyrin compound such as copper phthalocyanine, an aromatic tertiary amine such as 4,4′-bis [N-(1-naphthyl)-N-phenylamino]-biphenyl (NPB), a stilbene compound such as 4-(di-p-tolylamino)-4′-[4-(di-p-tolylamino)styryl] stilbenzene, a triazole derivative, a styryl amine compound. Moreover, it is also possible to employ a high molecular dispersed material formed by dispersing an amount of low molecular organic material for hole transportation in a predetermined amount of high molecular material such as polycarbonate.

The luminescent layer can be formed by any one of known luminescent materials. In detail, it is allowed to use fluorescent organic materials, including an aromatic dimethylidyne compound such as 4,4′-bis(2,2′-diphenyl vinyl)-biphenyl (DPVBi), a styryl benzene compound such as 1,4-bis(2-methyl styryl) benzene, a triazole derivative such as 3-(4-biphenyl)-4-phenyl 5-t-butylphenyl 1,2, 4-triazole (TAZ), an anthraquinone derivative, and a fluorenone derivative. Further, it is also possible to use a fluorescent organic metal oxide such as (8-hydroxy quinolynate) aluminum complex (Alq₃), and a high molecular material such as polyfluorenes and polyvinyl carbazoles (PVK). Moreover, it is allowed to employ an organic material capable of utilizing (for the purpose of luminescence) a phosphorescence from triplet excitons of a platinum complex or an iridium complex. Besides, it is also possible for the luminescent layer to further contain hole transportation material, electron transportation material, additives (a donor, an acceptor, etc.), or a luminescent dopant. Alternatively, these materials may be dispersed in high molecular material or inorganic material.

The electron transporting layer can be formed by any one of various known compounds, provided that it has a function of transporting electrons injected from the cathodes into the luminescent layer. In detail, it is allowed to use an organic material such as a nitro-substituted fluorenone derivative and an anthraquino dimethan derivative, a metal complex of an 8-quinolinol derivative, and a metal phthalocyanine, etc.

The cover 14 is formed by bonding a plate-like member (not shown) using an adhesive agent 16 containing spacers, a U-shaped member having a recess portion 15 formed by digging one step (shown in FIG. 2), or a member having a recess portion formed by digging two steps (not shown). Practically, the cover 14 can be formed by glass or plastic, provided it has a required transparency. However, it is preferable to use a glass (soda lime glass or non-alkali glass) to form the cover 14. In detail, the cover 14 has a transparent portion 14a corresponding to the luminescent area A and colored portions 14b (for preventing transmission vision) corresponding to the non-luminescent areas B. Specifically, the colored portions 14b of the cover 14 are located between the ends C of the cover 14 and the ends D of the area of the upper electrodes. Preferably, the areas 14b are colored by one of black, gray, and dark brown colors capable of uniformly absorbing lights of full wavelengths, provided that a selected color is capable of preventing a transmission vision and absorbing the lights having wavelengths within a visible-light range. A coloring method can be coloring the cover 14 itself, or simply forming a colored layer on the inner side (facing the substrate 12) of the cover 14. Here, the colored layer can be formed by film formation process based on printing, sputtering, vapor deposition, coating, and painting. Moreover, although not illustrated, in the case where λ/4 polarizing plate is provided on the surface of the substrate 12, it is allowed to form the colored portions with a light-reflective color capable of eliminating a reflected light. Preferably, it is recommendable to use a silver color.

The adhesive agent 16 can be thermal-setting type, chemical-setting type (two-liquid mixing), or light (ultraviolet light) setting type, and it is allowed to use an acryl resin, an epoxy resin, a polyester, a polyolefin. Particularly, it is preferable to use an ultraviolet-setting epoxy resin.

The desiccating means 17 can be a physical desiccating agent such as zeolite, silica gel, carbon, and carbon tube, a chemical desiccating agent such as an alkali metal oxide, metal halogenide, and chlorine peroxide, a desiccating agent formed by dissolving an organic metal complex in a petroleum-based solvent such as toluene, xylene, and aliphatic organic solvent, or a desiccating agent formed by dispersing an amount of desiccant particles in an amount of binder such as polyethylene, polyisoprene, and polyvinyl sinnate.

The organic EL display panel 11 of the present invention is manufactured by a first step of forming organic EL devices 13 on the flat transparent glass substrate 12, a second step of attaching the desiccating means 17 to the recess portion 15 of the cover 14, and a third step of bonding together the cover 14 and the substrate 12 using an adhesive agent 16.

In the step of forming the organic EL devices 13 on the substrate 12, at first, ITO material for forming the lower electrodes 13a serving as anodes is deposited as a thin film on the substrate 12 through vapor deposition or sputtering, followed by a photolithography process to form the deposited thin film into a desired pattern (representing a plurality of the lower electrodes). Then, the organic luminescent functional layer 13b is formed by a wet process such as spin coating, coating by dipping, ink jet, and screen printing, or a dry process such as vapor deposition and laser transferring. In detail, various materials for forming the hole transporting layer, the luminescent layer, and the electron transporting layer are successively deposited and laminated one above another. Subsequently, a plurality of stripe-like metal films are formed as upper electrodes 13c serving as cathodes, in a manner such that the upper electrodes 13c are arranged to be orthogonal to the lower electrodes 13a, thus forming a matrix by the lower electrodes 13a and the upper electrodes 13c. Here, the upper electrodes 13c are formed by vapor deposition or sputtering.

Next, in the step of attaching the desiccating means 17 to the recess portion 15 of the cover 14, at first, the recess portion 15 is formed on the glass substrate 14 (at least the non-luminescent areas of which have been colored) by press molding, etching, blast processing, or the like. Afterwards, the desiccating means 17 is attached to the recess portion 15 by means of an adhesive agent. Alternatively, the desiccating means 17 can also be fixed by an air permeable sheet consisting of paper or synthetic resin.

In the step of bonding together the cover 14 and the substrate 12 using an adhesive agent 16, at first, an appropriate amount (about 0.1-0.5 wt %) of granular spacers (preferably, glass or plastic particles) having a particle size of 1-100 λm is mixed into the adhesive agent 16 consisting of an ultraviolet-setting epoxy resin. Then, a dispenser is used to apply the adhesive agent 16 to the substrate 12 along the perimeter thereof corresponding to the side walls of the cover 14. Next, in an inert gas atmosphere such as argon gas, the cover 14 is bonded to the substrate 12 by the adhesive agent 16. Afterwards, the applied adhesive agent 16 is irradiated with an ultraviolet light irradiating from the substrate 12 side, thereby hardening the applied adhesive agent. In this way, the organic EL devices 13 can be encapsulated by bonding together the substrate 14 and the substrate 12 with an inert gas such as argon gas sealed there between.

In the present embodiment (first embodiment), at least certain portions of the cover 14b corresponding to the non-luminescent areas B are colored, thereby forming colored portions of the cover 14. In this way, it becomes possible to prevent a transmission vision through the organic EL display panel 11, thus improving an outer appearance of the display panel. Moreover, by inhibiting the transmission vision through the non-luminescent areas B surrounding the luminescent area A, it is allowed to improve the contrast of the organic EL display panel 11 itself.

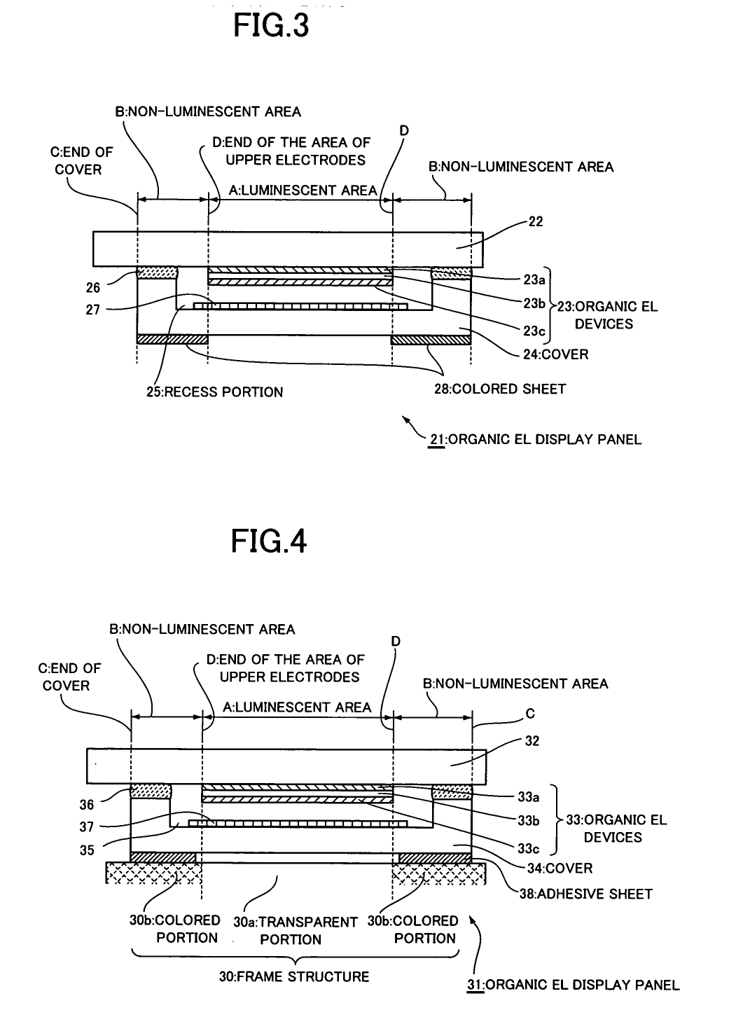

(Second Embodiment) FIG. 3 is an explanatory view schematically showing an organic EL display panel 21 formed according to a second embodiment of the present invention. As shown, lower electrodes 23a having a transparency are formed as thin films on a substrate 22. Subsequently, organic EL devices 23 are formed by laminating an organic luminescent functional layer 23b and upper electrodes 23c on the lower electrodes 23a. Then, in order to prevent the organic EL devices 23 (formed on the substrate 22) from the outside air, the substrate 22 and a cover 24 are bonded together by an adhesive agent 26, with a desiccating means 27 introduced into a recess portion 25 (facing the organic EL devices 23) of the cover 24. Further, colored sheets 28 are formed on the outer edges of the cover 24, thereby forming a completed organic EL display panel 21. In this way, the organic EL display panel 21 can be formed by using the same materials and the same method as in the above-described first embodiment. At this time, the colored portions as those involved in the first embodiment can still be formed in the cover 24, or can be omitted.

Here, as transmission vision preventing means of the organic EL display panel 21, the colored sheets 28 are attached to the non-luminescent areas B on the surface of the cover 24, thus making it possible to prevent the panel interior from being seen from the surface of the organic EL display panel 21. In fact, the colored sheet 28 can be formed by one of black, gray, and dark brown colors capable of uniformly absorbing lights of full wavelengths, provided that a selected color is capable of preventing a transmission vision and absorbing the lights having wavelengths within a visible-light range. Moreover, although not illustrated, in the case where λ/4 polarizing plate is provided on the surface of the substrate 22, it is allowed to form the colored portions with a light-reflective color capable of eliminating a reflected light. Preferably, it is recommendable to use a silver color. In fact, the colored sheet 28 can be a colored layer formed by printing, sputtering, vapor deposition, coating, or painting.

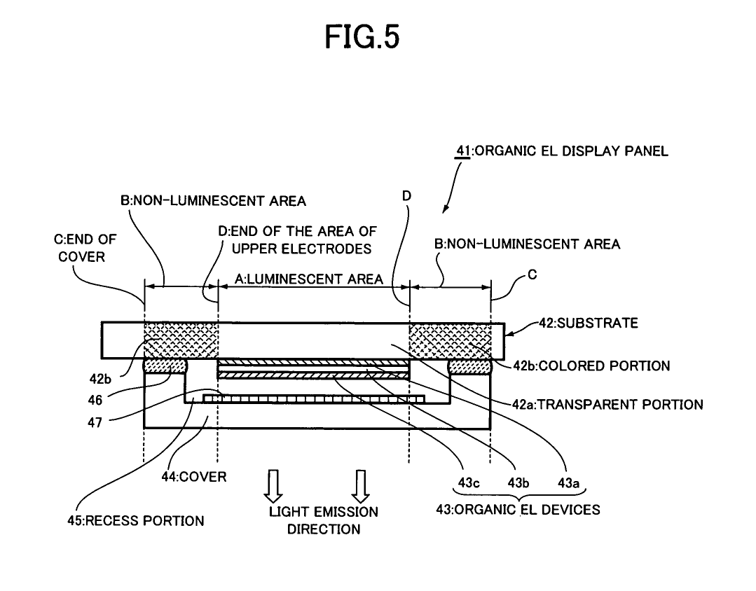

(Third Embodiment) FIG. 4 is an explanatory view schematically showing an organic EL display panel 31 formed according to a third embodiment of the present invention. As shown, lower electrodes 33a having a transparency are formed as thin films on a substrate 32. Subsequently, organic EL devices 33 are formed by laminating an organic luminescent functional layer 33b and upper electrodes 33c on the lower electrodes 33a. Then, in order to prevent the organic EL devices 33 (formed on the substrate 32) from the outside air, the substrate 32 and a cover 34 are bonded together by an adhesive agent 36, with a desiccating means 37 introduced into a recess portion 35 (facing the organic EL devices 33) of the cover 34. Further, the cover 34 is bonded to a frame structure 30 through adhesive sheets 38. Here, the adhesive sheets 38 can be obtained by providing an adhesion to both sides of the colored sheet 20 formed in the second embodiment. Alternatively, it is allowed to use an adhesive sheet without being colored. In this way, the organic EL display panel 31 can be formed by using the same materials and the same method as in the above-described first and second embodiments. At this time, the colored portions as those involved in the first embodiment can still be formed in the cover 34, or can be omitted.

The frame structure 30 includes a transparent portion 30a corresponding to the luminescent area A and colored portions 30b serving as transmission vision preventing means corresponding to the non-luminescent areas B. In fact, the colored portions 30b of the frame structure can be formed by one of black, gray, and dark brown colors capable of uniformly absorbing lights of full wavelengths, provided that a selected color is capable of preventing a transmission vision and absorbing the lights having wavelengths within a visible-light range. Moreover, although not illustrated, in the case where λ/4 polarizing plate is provided on the surface of the substrate 32, it is allowed to form the colored portions with a light-reflective color capable of eliminating a reflected light. Preferably, it is recommendable to use a silver color.

(Fourth Embodiment) FIG. 5 is an explanatory view schematically showing an organic EL display pane 141 formed according to a fourth embodiment of the present invention. As shown, the display panel 41 is not a bottom emission type display panel as shown in the above-described first through third embodiments, but a top emission type display panel which emits light from a cover 44 side. At first, lower electrodes 43a are formed as thin films on a substrate 42. Subsequently, organic EL devices 43 are formed by laminating an organic luminescent functional layer 43b and upper electrodes 43c on the lower electrodes 43a. Then, in order to prevent the organic EL devices 43 (formed on the substrate 42) from the outside air, the substrate 42 and a cover 44 are bonded together by an adhesive agent 46, with desiccating means 47 introduced into a recess portion 45 (facing the organic EL devices 43) of the cover 44. Alternatively, the desiccating means 47 can be located in positions corresponding to the non-luminescent areas D (not shown) In this way, the organic EL display panel 41 can be formed by using the same materials and the same method as in the above-described first through third embodiments. Besides, for curing the adhesive agent 46, it is also allowed to emit an ultraviolet light from the cover 44 side.

In practice, the substrate 42 can be formed by glass or plastic, provided it has a required transparency. However, it is preferable to use a glass (soda lime glass or non-alkali glass) to form the substrate 42. In detail, the substrate 42 has a transparent portion 42a corresponding to the luminescent area A and colored portions 42b (for preventing transmission vision) corresponding to the non-luminescent areas B. Specifically, the colored portions 42b of the substrate 42 are located between the ends C of the cover and the ends D of the area of the upper electrodes. Preferably, the areas 42b are colored by one of black, gray, and dark brown colors capable of uniformly absorbing lights of full wavelengths, provided that a selected color is capable of preventing a transmission vision and absorbing the lights having wavelengths within a visible-light range. A coloring method can be coloring the substrate 42 itself, or simply forming a colored layer on the inner side (facing the substrate 42) of the cover 44. Here, the colored layer can be formed by film formation process based on printing, sputtering, vapor deposition, coating, and painting. Moreover, although not illustrated, in the case where λ/4 polarizing plate is provided on the surface of the cover 44, it is allowed to form the colored portions with a light-reflective color capable of eliminating a reflected light. Preferably, it is recommendable to use a silver color.

The organic EL display panel 11 and its manufacturing method have been described in the above first through fourth embodiments. However, some modifications not departing from the gist of the present invention are also included in the present invention. For example, the organic EL display panel 11 can be driven not only by a passive driving method, but also by an active driving method based on TFT. Moreover, adhesive agents 16, 26, 36, and 46 can also be colored provided that their functions are not spoiled. At this time, although the adhesive agents 16, 26, 36, and 46 can be colored with any desired color, they are preferable to be colored with shallow black or shallow gray colors. By coloring the adhesive agents, it is possible to improve the outer appearance of the organic EL display panels 11, 21, 31, and 41, and to improve the contrast thereof.

Furthermore, as means for preventing an undesired transmission vision from the outside of the display panel, the present invention provides the colored portions 14b in the cover, the colored sheets 28, the colored portions 30b in the frame structure, and the colored portions 42b in the substrate. However, the present invention should not be limited to these embodiments. In fact, it is also possible to cover the entire surface of the cover 24 with the colored sheet 28, and to have the entire surface of the frame structure colored, as well as to have the entire surface of the substrate 42 colored. Further, the transmission vision preventing means can also be located in the luminescent area, provided that the non-luminescent areas have means for preventing light transmission through the display panel. By coloring the entire surface of the cover or substrate, even if the lower electrodes 13a, 23a, 33a, and 43 and the upper electrodes 13c, 23c, 33c, and 43c are all formed by transparent material, it is still possible to prevent the interior of the display panel from being seen through the entire surface of the organic EL display panels 11, 21, 31, and 41.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. An organic EL display panel including a cover which has a transparency and is provided for enclosing organic EL device(s) formed on a substrate having a transparency, characterized in that at least non-luminescent areas of the organic EL display panel are provided with transmission vision preventing means.

2. The organic EL display panel according to claim 1, wherein the transmission vision preventing means is formed by coloring at least relevant portions of the cover corresponding to said non-luminescent areas.

3. The organic EL display panel according to claim 1, wherein the transmission vision preventing means is formed by providing colored layer on the cover's one surface located away from the substrate.

4. The organic EL display panel according to claim 1, wherein the transmission vision preventing means is formed by attaching colored sheet to the backside of the cover, located at least in relevant portions corresponding to said non-luminescent areas.

5. The organic EL display panel according to claim 1, wherein the transmission vision preventing means is a frame structure, at least relevant portions of which are colored, said relevant portions being close to the cover and corresponding to said luminescent areas.

6. The organic EL display panel according to claim 1, wherein the transmission vision preventing means is formed by coloring at least relevant portions of the substrate corresponding to said non-luminescent areas.

7. The organic EL display panel according to any one of claims 1 to 6, wherein the transmission vision preventing means is formed by coloring an adhesive agent.

8. A method of manufacturing an organic EL display panel including a cover which has a transparency and is provided for enclosing organic EL device(s) formed on a substrate having a transparency, characterized in that the method involves a step of forming transmission vision preventing means in at least non-luminescent areas of the organic EL display panel.

9. The method according to claim 8, wherein the transmission vision preventing means is formed by coloring at least relevant portions of the cover corresponding to said non-luminescent areas.

10. The method according to claim 8, wherein the transmission vision preventing means is formed by providing colored layer on the cover's one surface located away from the substrate.

11. The method according to claim 8, wherein the transmission vision preventing means is formed by attaching colored sheet to the backside of the cover, located at least in relevant portions corresponding to said non-luminescent areas.

12. The method according to claim 8, wherein the transmission vision preventing means is a frame structure, at least relevant portions of which are colored, said relevant portions being close to the cover and corresponding to said non-luminescent areas.

13. The method according to claim 8, wherein the transmission vision preventing means is formed by coloring at least relevant portions of the substrate corresponding to said non-luminescent areas.

14. The method according to any one of claims 8 to 13, wherein the transmission vision preventing means is formed by coloring an adhesive agent.
